(19) United States
(12) Patent Application Publication
(10) Pub. No.: US 2019/0173310 A1
(43) Pub. Date: Jun. 6, 2019

(54) Electromechanical set replacing a Diesel Engine

(71) Applicant: Saud AlZamil, Khobar (SA)

(72) Inventor: Saud AlZamil, Khobar (SA)

(21) Appl. No.: 15/500,145

(22) PCT Filed: Oct. 9, 2015
(86) PCT No.: PCT/SA2015/050003

§ 371 Date: Apr. 28, 2017

(30) Foreign Application Priority Data
Mar. 16, 2015 (SA) 115360383

(51) Int. Cl. H02J 7/14; H02G 11/02; B60L 5/22; E02F 3/36

(52) U.S. Cl. CPC H02J 7/1446; E02F 3/3654; B60L 5/22; H02G 11/02

(57) ABSTRACT

The Electromechanical Set is a replacement of a Diesel engine for many Heavy and Light Machinery, which able to use this innovation instead of a diesel Engine in many Machines operating. And that by connecting Electricity from Fixed Power supply (1), with Cable (2), to go over high Stand (3), and to roll the Cable over a Reel (5), To be linked with Electrical Distributor which has Tow Switches (10) to operate The Reel Dynamo (6), and the Electromechanical Set Dynamo (15), which is linked with pushing Gears (16) to operate the Diesel Machinery.

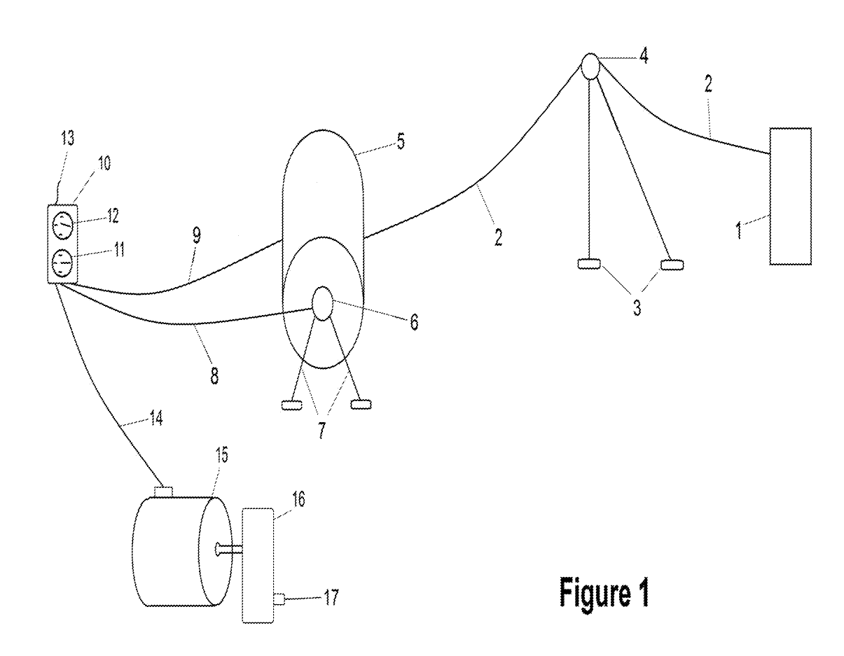

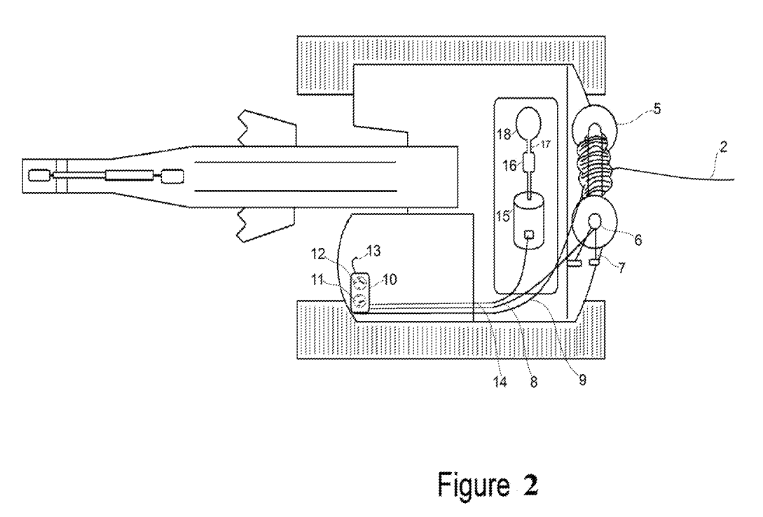

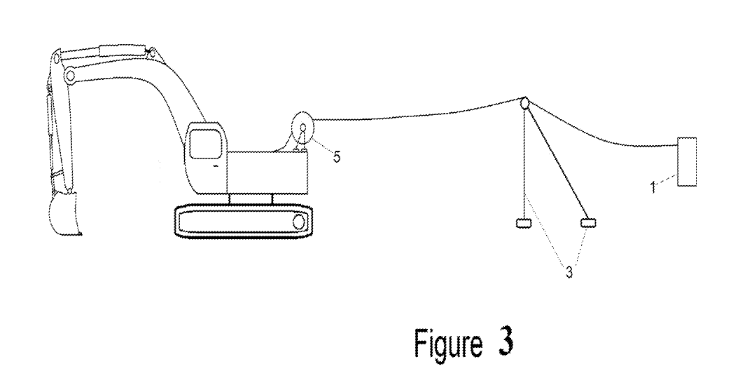

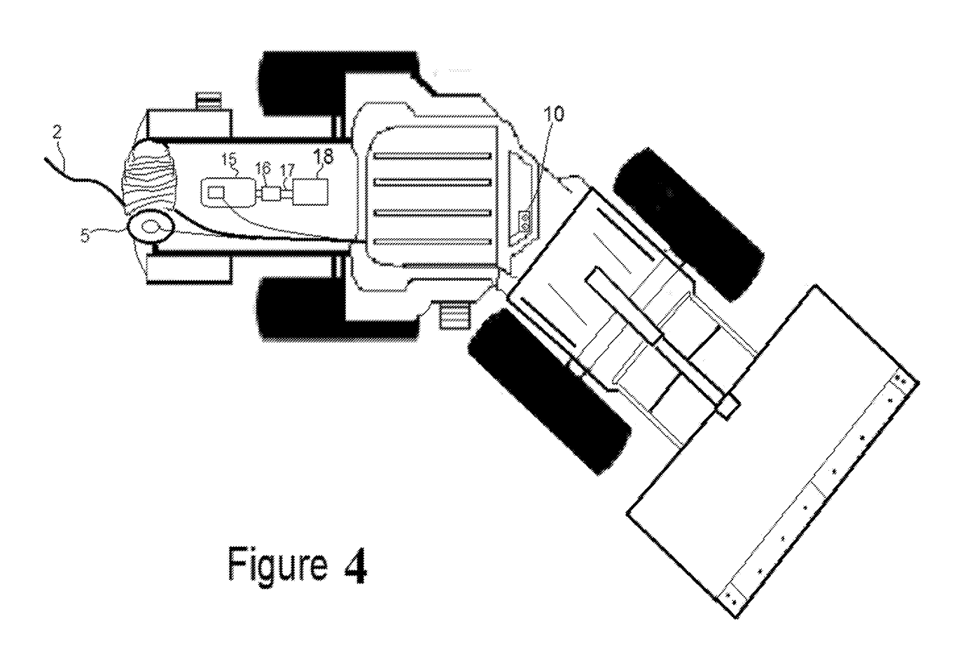

### BACKGROUND OF THE INVENTION

The Electromechanical set is a simple innovation to replace a diesel Engine in many Diesel machines, which is not spouse to be moving much such as the hydraulic excavator and other machines that can be operated by the Electromechanical set. The Set consist of sex elements Cable (2), High Stand (3), Cable Reel (5), Dynamo (15) and a Gear Box (16). In combining these elements it is possible to operate the main Gears and Hydraulic Pumps in Machines.

In the previous technology the machines is been operated by diesel Engine, which has a high value and in complicated format and it needs more maintenance. In this Innovation the technology is simple and it doesn't need much maintenance compared to the Diesel Engine. And the Machines can be working in better conditions with the set of the electromechanical innovation. The disadvantages of the set that the machines would be linked to a Cable which would eliminate the moving of the machines, and if there would be another machines in the field. Methods have been addressed in China invention No. 103758173 by Sani Shanghai Heavy Equipment Co. and it is to manufactures electric hydraulic excavator, to safe in energy consumption and solve heat problems in operating diesel engines. And another invention Japan 2005155251 by Sumitomo construction MFG for the production of hydraulic equipment using high torque generators has been touched. At the present invention it describes electromechanical set fit to be an alternative to the diesel engines of most kinds of Machineries to operate with the Newton Meter and speed rotation needed, specially for machines that doesn't move far distance.

### GENERAL DESCRIPTION OF INNOVATION

The objective of the innovation is to find a set works electromechanically, to be replacing Diesel Engine for many machines. In this innovation the hydraulic Excavator and the wheel loader are the example to explain the process of operating the Electromechanical Set in the best way, and that the machine either works by main hydraulic pump, or by running the main gear. In hydraulic machines, is to operate the main pump to run other pumps to move the hydraulic arms And the main purpose of the machine is to dig not to move much, and then the electromechanical set is very durable for the work, to replace the diesel engine. In other machines the electromechanical set can be used, by linking the set to the main gear (the beam which push the gears box) to operate the machine and in case of requests to run the machine in higher speed a device of Variable Frequency Drive can be used or fast motors as servo type motors can be used as well, but the distance moving element is disadvantage during the work. And it can be possible to develop the Set by adding a long flat spring inside the Reel to keep the Cable tightly stretched to avoid going over it, and adding another Reel by the high Stand which holds the cable can be an advantage. The Goal of the innovation is to save economically and in maintenance in machines that can be operated by the Electromechanical Set.

### SUMMARY OF FIGURES AND DRAWINGS

1—FIG. (1): Side Drawing of the Electromechanical Set Components.

2—FIG. (2): Top drawing of the Electromechanical Set and how it is been placed over Excavator.

3—FIG. (3): Side drawing of the Electromechanical Set and how it is been placed over Excavator.

4—FIG. (4): Top drawing of the Electromechanical Set and how it is been placed over Wheel Loader.

### INNOVATION DESCRIPTION IN DETAILS

The Electromechanical Set is been operated by high voltage power, which can be the regular houses Power Transformers that supply a normal house. In the Beginning the high Voltage Cable is been linked to a power source and as it is shown in the FIG. (1) that the cable (2) goes from the transformer (1) to the high Stand (3) which keeps the Cable over the ground and hold it in top of the base by the wheel number (4). And Cable (2) is been carried from over the base to the Cable Reel (5) which stand over base (7) and it has an electrical machine (6) to roll the cable over the Reel mechanically which the power been supplied by wire (8). And Cable (9) is been linked before it is been rolled completely to a Power Distributor (10) which consists of Tow Switches. Switch (12) has three power options to operate the Sets Dynamo. Switch (13) to operate rolling the Cable over the Reel. Wire (13) is for a general use for the Machine. And from Distributor (10) a high voltage Cable (14) goes to run the Sets Dynamo (15). Then (16) a Gear Box to increase the power moving of beam (17) which is to be linked to the main machine gears and hydraulic pump engines to be operated, and linking the gear box to the main gear boxes or hydraulic pumps must be with proper coupling tools of each machines for stable operating. And gear boxes may take several aspects and it can be customized as per request to reach the requirements in terms of momentum in metric or rotational speed and often gearboxes with a single-stage, could be considered for the equipment of some companies such as SEW euro Drive and it provides several models of gear motors and gear boxes such as, RX Series a type of electrical motor gearbox which has capacity of 30 kW per hour that reach Newton meters power of 1450 and speed 1280 rpm The output may be sufficient to run a large number of medium-sized diesel machines, and in case the machine require higher speed, fast motor model servo produced as well from SEW which can reach a high speed, and for large diesel machinery, Dynamos with electric capacity up to 200 kW per hour, combined with gear box model of helical H series been manufactured in many gear box companies as customized requests and it can be fixed at low ratio to increase the momentum of metric and also speed can be increased by using Inverter, Variable Frequency Drive to reach the desired speed and power. To see how the electromechanical Set would look like in machines please see FIG. (2) to see a top drawing of a Hydraulic Excavator and how the Set is been placed as Cable (2) goes in the Reel (5) and the machine to roll the Cable (6) and the base (7) of the reel is been placed in the back of the Machine, and Cable (9) comes out of the reel to connect to the Electric Distributor (10) and Switches (12) to operate Reel to roll the cable and been linked with wire (8). And see wire (13) for general use in the Machine. And Switch (12) is to operate the Sets Dynamo (15) through Cable (14) to operate the Dynamo (15) to push the Gear Box (16) and been linked with beam (17) and to use the proper coupling parts for each machine for better performance to operate the main Hydraulic pump (18) as Excavator works by a major hydraulic pumps. And for a side look of how it looks on Excavator please see FIG. (3) and the main power supply (1) and Cable goes over the high Stand (3) to reach the Excavator Reel (5). And it can be possible to develop the Set to add a long flat spring inside the Reel to keep the Cable tightly stretched to avoid going over it, and adding another Reel by the high Stand which holds the cable can be an advantage. For another example of how the Electromechanical Set would look like please see FIG. (4) Top drawing of the Electromechanical Set and how it is been placed over Wheel Loader as Cable (2) goes in to the reel (5) and the Cable goes in to the Driving Cabin and as the Distributor and switches (10) to operate the Sets Dynamo (15) to push Gearbox (16) and been linked with the Major Gear box of the machine (18) with the proper coupling parts at the beam (17). By operating the main Gear box (18) the Wheel loader is going to be working in its normal condition by keeping all the hydraulic systems unchanged, only engine and parts with it are the ones to be replaced. And to have a long flat spring inside the Reel to keep the Cable tightly stretched.

1-4. (canceled)

5: An electromechanical apparatus for replacing a diesel engine, comprising:
a) a dynamo for converting mechanical rotation to electricity, said dynamo having an electrical output;
b) an electrical cable terminating at a transformer;
c) a rotatable cable reel for containing said electrical cable, said rotatable cable reel having an electric motor therein for rotating said rotatable cable reel;
d) an electrical wire having two ends, one end being operatively connected to the electrical output of said dynamo and the other end being operatively connected to said rotatable cable reel motor;
e) an elevated stand to support said electrical cable at a predetermined height, said elevated stand having a pulley over which said electrical cable runs; and
f) a gear box operatively connected to said electrical motor of said rotatable cable reel and to at least one external physical device.

6: The electromechanical apparatus in accordance with claim 5, wherein said at least one external physical device is chosen from the group: external machine gear box and external hydraulic pump engine.

7: The electromechanical apparatus in accordance with claim 5, further comprising an electrical distributor comprising tow switches, said electrical distributor being operatively connected to said electrical output of said dynamo, to said electrical cable reel motor, and to said gear box for the selective energization thereof.

8: The electromechanical apparatus in accordance with claim 5, wherein said electrical cable reel comprises a flat spring to maintain tension of said electrical cable as it moves.
